(19) United States
(12) Patent Application Publication
(10) Pub. No.: US 2018/0310128 A1
(43) Pub. Date: Oct. 25, 2018

(54) LOCATION DETERMINATION SYSTEM WITH MOBILE WIRELESS TERMINAL

(71) Applicant: KABUSHIKI KAISHA TOSHIBA, Tokyo (JP)

(72) Inventor: Hiroyuki FUJIKI, Fujisawa Kanagawa (JP)

(21) Appl. No.: 15/693,426

(22) Filed: Aug. 31, 2017

(30) Foreign Application Priority Data
Apr. 25, 2017 (JP) 2017-086461

(51) Int. Cl. H04W 4/02

(52) U.S. Cl. CPC H04W 4/023; H04W 88/02

(57) ABSTRACT

A mobile wireless terminal includes a transmission and reception circuit including an antenna that transmits and receives wireless signals, and a processor. The processor receives, via the antenna, a wireless signal from a wireless device, and calculates a location of the mobile wireless terminal based on a variation in strength of the wireless signal over an arbitrary time interval. Then, the processor determines, based on the calculated location of the mobile wireless terminal, whether a distance from the mobile wireless terminal to the wireless device is less than a predetermined threshold, and when the distance is determined to be less than a predetermined threshold, transmits a request, via the antenna, for information associated with the wireless device. Upon receipt of the information associated with the wireless device, in response to the request via the antenna, the processor controls a display device to display the information associated with the wireless device.

### CROSS-REFERENCE TO RELATED APPLICATION

This application is based upon and claims the benefit of priority from Japanese Patent Application No. 2017-086461, filed Apr. 25, 2017, the entire contents of which are incorporated herein by reference.

### FIELD

Embodiments described herein relate generally to a location determination system with a mobile wireless terminal.

### BACKGROUND

In recent years, a method has been used in which a location of a mobile wireless terminal is specified within a building or the like based on information that is obtained from a plurality of wireless apparatuses.

### DESCRIPTION OF THE DRAWINGS

FIG. 1 is a diagram of an image of a location determination system according to a first embodiment.

FIG. 2 is a block diagram illustrating a configuration of a mobile wireless terminal.

FIG. 3 is a block diagram illustrating a configuration of a beacon apparatus.

FIG. 4 is a block diagram illustrating a configuration of a cloud server.

FIG. 5A is an example of a flowchart of operations for the beacon apparatus according to the first embodiment.

FIG. 5B is an example of a flowchart of operations for the mobile wireless terminal according to the first embodiment.

FIG. 5C is an example of a flowchart of operations for the cloud server according to the first embodiment.

FIG. 6 is a reference diagram for describing an example of the location determination system according to the first embodiment.

FIG. 7 is a diagram of an image of a location determination system according to a second embodiment.

FIG. 8 is a block diagram illustrating a configuration of a mobile wireless terminal according to the second embodiment.

FIG. 9 is a block diagram illustrating a configuration of a reception apparatus according to the second embodiment.

FIG. 10A is an example of a flowchart of operations for the mobile wireless terminal according to the second embodiment.

FIG. 10B is an example of a flowchart of operations for the reception apparatus according to the second embodiment.

FIG. 10C is an example of a flowchart for a cloud server according to the second embodiment.

FIG. 11 is a reference diagram for describing a location determination system according to a third embodiment.

FIG. 12A is an example of a flowchart of operations for a beacon apparatus according to the third embodiment.

FIG. 12B is an example of a flowchart of operations for a mobile wireless terminal according to the third embodiment.

### DETAILED DESCRIPTION

Embodiments provide a mobile wireless terminal and a wireless apparatus that specify a place by detecting a location relative to a wireless apparatus, and a location determination system that includes the mobile wireless terminal and the wireless apparatus, and a method for providing location specific information to the mobile wireless terminal.

In general, according to one embodiment, there is provided a mobile wireless terminal includes a display device, a transmission and reception circuit including an antenna that transmits and receives wireless signals, and a processor. The processor receives, via the antenna, a wireless signal from a wireless device, and calculates a location of the mobile wireless terminal based on a variation in strength of the wireless signal over an arbitrary time interval. Then, the processor determines, based on the calculated location of the mobile wireless terminal, whether a distance from the mobile wireless terminal to the wireless device is less than a predetermined threshold, and when the distance from the mobile wireless terminal to the wireless device is less than a predetermined threshold, transmits a request, via the antenna, for information associated with the wireless device. Upon receipt of the information associated with the wireless device, in response to the request via the antenna, the processor controls the display device to display a screen that includes the information associated with the wireless device.

Embodiments will be described below with reference to the drawings.

It is noted that a relationship between the thickness and width of each component in the drawings, a ratio in size between components, and the like are not necessarily the same as those in the real world. Furthermore, in some cases, even the same components are expressed in different dimensions or at different ratios among the drawings.

### First Embodiment

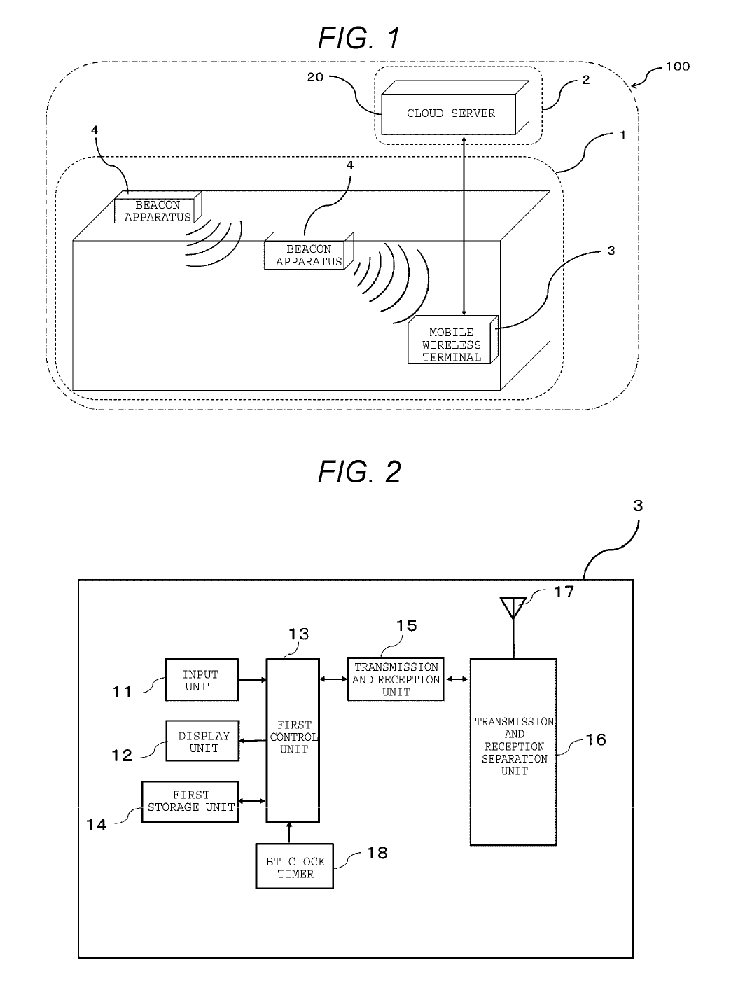

A first embodiment of the present disclosure is described with reference to FIG. 1. FIG. 1 is a diagram of a location determination system according to the first embodiment.

### Example of a Configuration of the Entire Location Determination System

A configuration of an entire location determination system 100 according to the first embodiment is described with reference to FIG. 1. As illustrated in FIG. 1, a location determination system 100 includes a first system 1 and a second system 2.

### First System 1

The first system 1 includes a mobile wireless terminal 3 and a plurality of beacon apparatuses (which are examples of wireless apparatuses) 4. Communication is performed between the mobile wireless terminal 3 and a beacon apparatus 4 in compliance with BLUETOOTH® protocol, Wi-Fi® protocol, a low energy wireless communication protocol, or the like.

The mobile wireless terminal 3, as illustrated in FIG. 2, has a data processing system including an input unit 11, a display unit 12, a first control unit 13, a storage unit 14, and the like, and a communication processing system including a transmission and reception unit 15 (which is, e.g., a circuit), a transmission and reception separation unit 16, a transmission and reception antenna 17, and a clock timer 18. The first control unit 13 functions as a communication control unit.

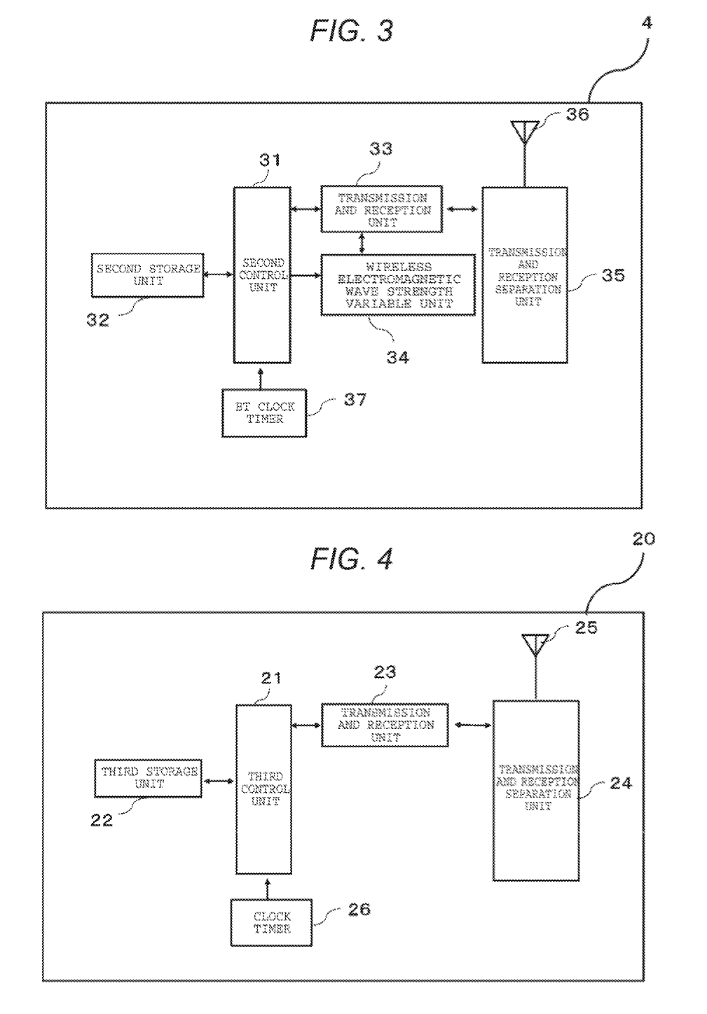

The beacon apparatus 4, as illustrated in FIG. 3, has a second control unit 31, a second storage unit 32, a transmission and reception unit 33 (which is, e.g., a circuit), a wireless electromagnetic wave strength variable unit 34, a transmission and reception separation unit 35, a transmission and reception antenna 36, a BT clock timer 37, and the like.

The input unit 11 includes keys and the like for inputting information necessary for operations in the mobile wireless terminal 3, such as powering on and off, activating of location display activation, and display mode selection.

The first control unit 13 controls the display unit 12 to display a coupon image, a map of the surroundings, or the like. The input unit 11 and the display unit 12 may be configured to be integrally combined, such as with a liquid crystal display panel and a touch panel on the front surface thereof or the like.

The first control unit 13, for example, controls the entire mobile wireless terminal 3, and includes a CPU as a main component thereof. The first control unit 13, for example, performs operations based on a program that is stored in the storage unit 14.

Communication control program 14a and location determination program 14b that are executed by the first control unit 13 are stored in a first storage unit 14. The first storage unit 14 may be, for example, a ROM, a RAM, an EEPROM, or the like. When an operation is performed by the first control unit 13, the first storage unit 14 functions as a working memory.

A BLUETOOTH® address (BT address) of the mobile wireless terminal 3, pieces of data for various frequency hopping patterns at the times of inquiry, calling, and communication, and the like are processed by the communication control program 14a and are stored in the first storage unit 14. Furthermore, a location detection processing routine that determines a location of the mobile wireless terminal 3 is included in the location determination program 14b that is stored in the first storage unit 14.

When functioning as a transmission unit, the transmission and reception unit 15 converts transmission packet data that is provided by the first control unit 13, into a radio frequency (RF) signal, and provides the resulting radio frequency signal to the transmission and reception antenna 17 through the transmission and reception separation unit 16, for transmission. Furthermore, when the transmission and reception unit 15 functions as a reception unit, the transmission and reception antenna 17 converts a reception RF signal that is provided from the transmission and reception separation unit 16, into a reception packet data, and provides the resulting reception packet data to the first control unit 13. Furthermore, the transmission unit and the reception unit may be separately provided.

The transmission and reception separation unit 16, which is a circuit, e.g., a duplex circuit, performs separation of the transmission system and the reception system. In a case where a transmission antenna and a reception antenna are separately provided, the transmission and reception separation unit 16 is unnecessary.

The transmission and reception antenna 17 emits a transmission RF signal wirelessly into the air and converts an arrival electromagnetic wave (e.g., a reception RF signal) into an electric signal. The transmission and reception antenna 17 is omnidirectional.

The clock timer 18 is a timer that generates various clock signals, such as BLUETOOTH® clock signals (BT clock signals), that specify a time position along the time axis.

The second control unit 31 in each beacon apparatus 4, includes, for example, a CPU as a main component thereof, and controls the entire beacon apparatus 4. The second control unit 31, for example, performs a control operation, in accordance with a communication control program (which uses fixed data and the like) that is stored in the second storage unit 32.

The second storage unit 32 stores a program that is to be executed by the second control unit 31 and functions as a working memory when an operation is performed by the second control unit 31. The second storage unit 32 maybe, for example, a ROM, a RAM, an EEPROM, or the like. The storage unit 32 stores location data (for example, a longitude, a latitude, coordinates, an altitude, and the like) of the beacon apparatus 4, a BT address of the beacon apparatus 4, a frequency hopping pattern, and the like.

The transmission and reception unit 33 converts the transmission packet data, which is provided from the second control unit 31, into an RF signal and provides the RF signal to the transmission and reception antenna 36 through the transmission and reception separation unit 35, for transmission. Furthermore, the transmission and reception antenna 36 converts the reception RF signal provided through the transmission and reception separation unit 36, into reception packet data and provides the resulting reception packet data to the second control unit 31.

Under the control of the second control unit 31, the wireless electromagnetic wave strength variable unit 34 generates a signal for an electromagnetic wave for transmission that is provided to the transmission and reception unit 33. The strength of the electromagnetic wave of the signal that is generated changes at an arbitrary time interval. The second control unit 31 may be performed in accordance with the program.

The transmission and reception separation unit 35 is a circuit that separates the transmission system and the reception system. In a case where the transmission antenna and the reception antenna are separately provided, the transmission and reception separation unit 36 is unnecessary.

The transmission and reception antenna 36 emits a transmission RF signal wirelessly into the air and converts an arriving electromagnetic wave (e.g., the RF reception signal) into an electric signal. The transmission and reception antenna 36 is intended to be omnidirectional. However, in a case where the transmission and reception antenna is in an installation location in which multipath transmission easily occurs, the transmission and reception antenna 36 may have a directionality toward a direction in which transmission and reception of a reflection wave is desired.

The clock timer 37 is a timer that generates various clock signals that specify the time. In the case of the present embodiment, the clock timer 37 of each beacon apparatus 4 is set to track the same time. For example, in accordance with a communication configuration that is not illustrated, the clock timer 37 performs synchronization to a standard time signal that indicates the domestic standard time. The domestic standard time information may be included in a magnetic wave from a global positioning system (GPS) satellite.

### Second System 2

As illustrated in FIG. 1, the second system 2 includes a cloud server 20. The cloud server 20 communicates with the mobile wireless terminal 3.

The cloud server 20, as illustrated in FIG. 4, includes a third control unit 21, a third storage unit 22, and the like, and a communication processing system with a transmission and reception unit 23, a transmission and reception separation unit 24, a transmission and reception antenna 25, a BT clock timer 26, and the like. The third control unit 21 functions as a communication control unit.

The third control unit 21, for example, controls the entire cloud server 20, and includes a CPU as a main component thereof. The third control unit 21, for example, performs a control operation in accordance with a control program that is stored in the third storage unit 22.

A program that is executed by the third control unit 21 is stored in the third storage unit 22. The third storage unit 22 is, for example, a ROM, a RAM, an EEPROM, or the like. Furthermore, when an operation is performed by the third control unit 21, the third storage unit 22 functions as a working memory.

A communication control program 22a that is stored in the third storage unit 22 is a program for performing communication between the cloud server 20 and the mobile wireless terminal 3. Furthermore, an inquiry program 22b that is stored in the third storage unit 22 also includes a processing routine that requests information from the beacon apparatus 4. The inquiry program 22b causes the cloud server 20 to transmit detailed location information or data, such as a coupon, which is used in a store or the like that is associated with the beacon apparatus 4, to the mobile wireless terminal 3.

When functioning as a transmission unit, the transmission and reception unit 23 converts transmission packet data that is provided from the third control unit 21, into an RF signal, and provides the resulting radio frequency signal to the transmission and reception antenna 25 through the transmission and reception separation unit 24, for transmission. Furthermore, when the transmission and reception unit 23 functions as a reception unit, the transmission and reception antenna 25 converts a reception RF signal that is provided through the transmission and reception separation unit 24, into a reception packet data, and provides the resulting reception packet data to the third control unit 21. Furthermore, the transmission unit and the reception unit may be separately provided.

### Operation

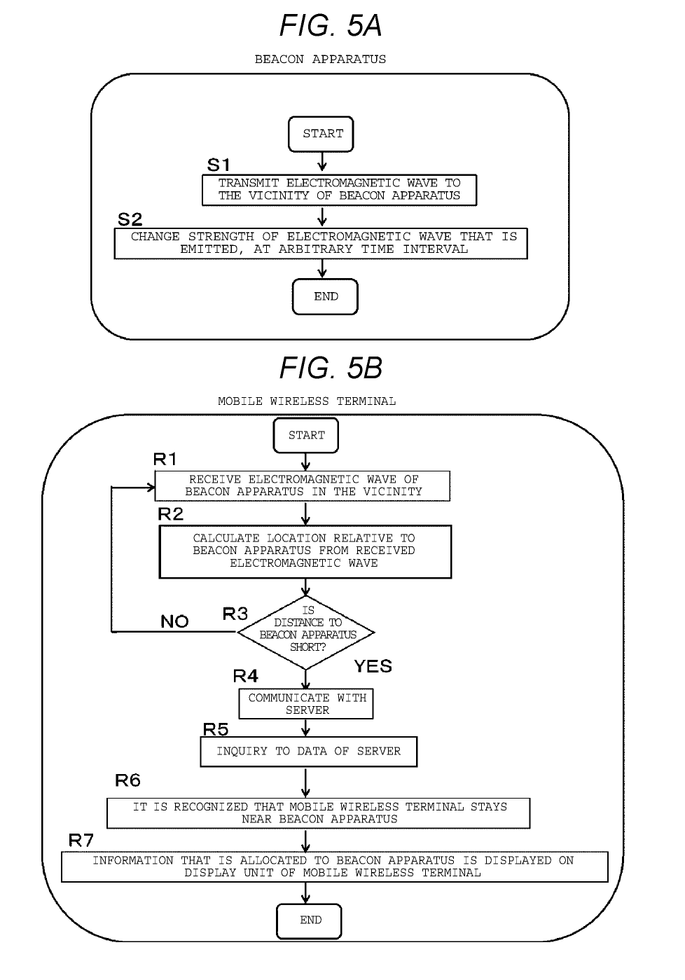

Next, the operation of the embodiment is described with reference to flowcharts with reference to FIG. 5A to 5C.

As illustrated in FIG. 5A, the beacon apparatus 4 transmits a wireless signal that carries apparatus-unique data (e.g., ID, location information, or the like), as an electromagnetic wave (Step S1). At that time, a strength of the electromagnetic wave that is transmitted at an arbitrary time interval is changed by a wireless electromagnetic wave strength variable unit 34 (Step S2).

On the other hand, as illustrated in FIG. 5B, the mobile wireless terminal 3 first receives an electromagnetic wave from the beacon apparatus 4 in the vicinity (Step R1). Next, the first control unit 13 of the mobile wireless terminal 3 calculates a location relative to the beacon apparatus 4 based on a change in the strength of the received electromagnetic wave (Step R2). The first control unit 13 of the mobile wireless terminal 3 compares the calculated relative location with a threshold (which is a reference value when it is determined that a distance to the beacon apparatus is short) that is set in advance, and determines whether or not the mobile wireless terminal 3 is in the vicinity of the beacon apparatus 4 (Step R3). In a case where it is determined that a distance between the beacon apparatus 4 and the mobile wireless terminal 3 is not short (NO in Step R3), turning to step R1 takes place again. On the other hand, in a case where it is determined that the distance between the beacon apparatus 4 and the mobile wireless terminal 3 is short (YES in Step R3), the mobile wireless terminal 3 starts communication with the cloud server 20 (Step R4). The first control unit 13 of the mobile wireless terminal 3 requests the unique data of the beacon apparatus 4 from the cloud server 20 (Step R5). The cloud server 20 recognizes that the mobile wireless terminal 3 stays close to the beacon apparatus 4, and transmits information (e.g., information relating to the surroundings of the beacon apparatus 4, a coupon ticket, or the like) that is allocated to each beacon apparatus, to the mobile wireless terminal 3 (Step R6). Thereafter, the first control unit 13 of the mobile wireless terminal 3 displays the received information on a display unit (Step R7).

The cloud server 20, as illustrated in FIG. 5C, first starts communication with the mobile wireless terminal 3 (step Q1). Next, the cloud server 20 receives the unique data of the beacon apparatus 4 that is in communication with the mobile wireless terminal 3, from the mobile wireless terminal 3 (Step Q2). The cloud server 20 transmits information corresponding to the unique data of the beacon apparatus 4 to the mobile wireless terminal (Step Q3).

### Operation and Effect

An operation and an effect according to the present embodiment is described here with reference to a specific example.

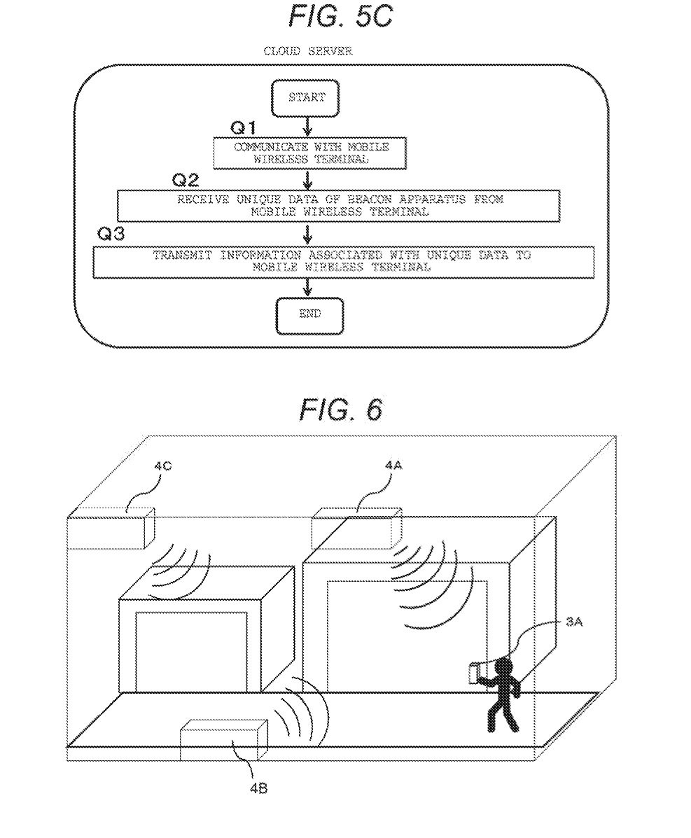

As illustrated in FIG. 6, it is assumed that a pedestrian operates the mobile wireless terminal 3A in indoor facilities and the beacon apparatuses 4A, 4B, and 4C in the vicinity transmits signals. At this time, the strength of the electromagnetic wave of the signal that is emitted by each beacon apparatus 4, for example, changes in a range of approximately −40 dB to 0 dB. Two or more strengths of the electromagnetic wave may be set, and may be changed at an arbitrary time interval or changed with a predetermined time period. Furthermore, it is desirable that a plurality of beacon apparatuses are provided in a linearly symmetrical manner or in such a manner that a positional relationship in which a tetrahedron is formed when linking the plurality of beacon apparatuses. In such a case, the precision with which a location of the mobile wireless terminal 3 with respect to the beacon apparatus 4 is specified is improved. Furthermore, it is desirable that each beacon apparatus transmits a signal with a different periodicity. This is because there is a concern that when signals are synchronized with each other, the signals will interfere with each other and noise will occur.

The mobile wireless terminal 3A calculates a relative location with respect to the beacon apparatus 4A based on the high and low strength levels of the electromagnetic wave of the received unique data of the beacon apparatus 4A. Furthermore, in the same manner, the processing is performed on the signals that are received from the beacon apparatuses 4B and 4C. Next, the mobile wireless terminal 3A requests, from a server, the unique data corresponding to each of the beacon apparatuses 4A, the beacon apparatus 4B, and the beacon apparatus 4C. The unique data, for example, is an ID that is given to each beacon, or location information of a beacon. Accordingly, the third control unit 21 of the cloud server 20 specifies where the mobile wireless terminal 3A is located, in more detail, and determines that among a plurality of beacon apparatuses that are present in a fixed place, the beacon apparatus 4A is the closest. Then, the cloud server 20 transmits information (e.g., a coupon ticket issued by a store in the vicinity of the beacon apparatus 4A, a map of the surroundings, or the like) that corresponds to the beacon apparatus 4A, to the mobile wireless terminal 3A. The received information is displayed on a display unit of the mobile wireless terminal 3A.

As described above, the mobile wireless terminal 3 can receive a signal from a GPS satellite, and specify a place where the mobile wireless terminal 3 equipped with a wireless function is located, with higher precision, inside of a house or vehicle in which location information cannot be acquired from the GPS satellite.

Furthermore, in the related art, because transmission is performed with the strength of the electromagnetic wave being fixed, in a case where the electromagnetic strength is at a high level, it is determined that a reception strength is in a saturated state, and it is easy for deviation to occur in the result of the calculation. On the other hand, the beacon apparatus 4 of the location determination system 100 according to the first embodiment sends out a wireless signal that varies in strength. Thus, depending on the varying strength of the electromagnetic wave from the beacon apparatus 4, the mobile wireless terminal 3 can identify the beacon apparatus that performs transmission with higher precision based on the high and low levels of the electromagnetic wave and can specify the location of the mobile wireless terminal 3.

### Second Embodiment

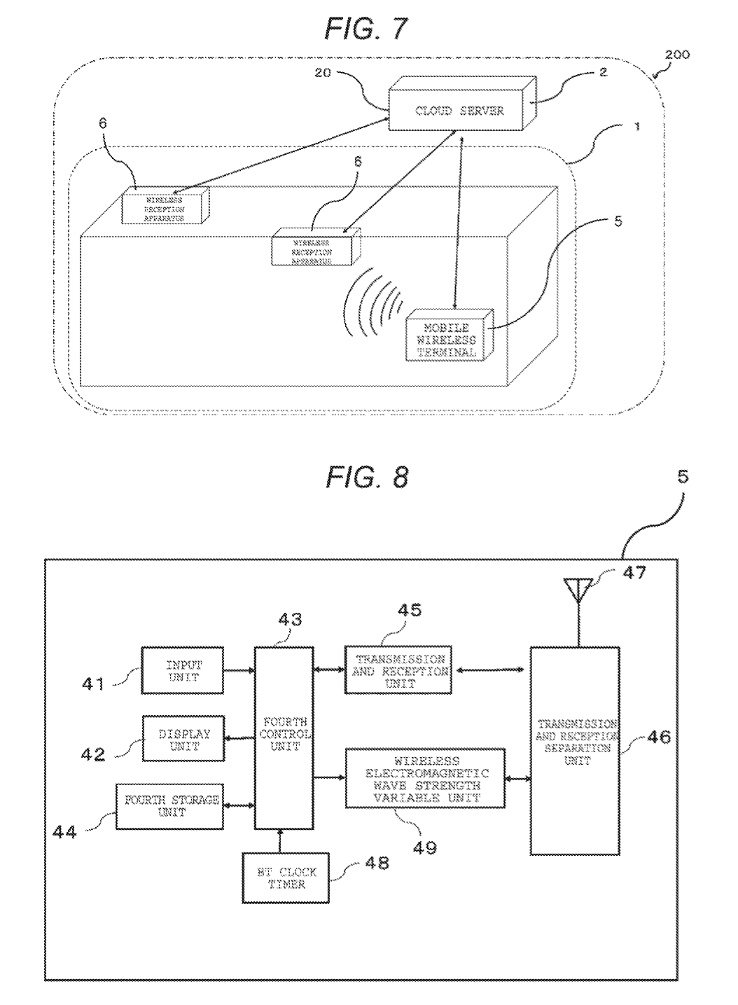

Next, a second embodiment will be described. FIG. 7 is a reference diagram of a location determination system 200 according to the second embodiment. In the location determination system 200, unlike in the first embodiment, a mobile wireless terminal 5 sends out a wireless signal that carries data unique to the mobile wireless terminal 5, while varying the strength of the electromagnetic wave at an arbitrary time interval (which, for example, ranges from 0 dBm to −40 dBm). Moreover, the sent-out electromagnetic wave is received by a wireless reception apparatus 6 that is provided inside of a vehicle or a house. Unique data of the mobile wireless terminal 5 is registered in advance in the reception apparatus 6, and when the registered mobile wireless terminal 5 approaches the reception apparatus 6, the reception apparatus 6 recognizes that the mobile wireless terminal 5 is located nearby.

FIG. 8 is a block diagram illustrating a configuration of a mobile wireless terminal 5. The mobile wireless terminal 5 is different from the mobile wireless terminal 3 according to the first embodiment in that the mobile wireless terminal 5 includes a wireless electromagnetic wave strength variable unit 49. The mobile wireless terminal 5 transmits a wireless signal while the wireless electromagnetic wave strength variable unit 49 varies the strength of the electromagnetic wave at an arbitrary time interval. Furthermore, instead of the wireless electromagnetic wave strength variable unit 49, the processing maybe performed in the fourth control unit 43.

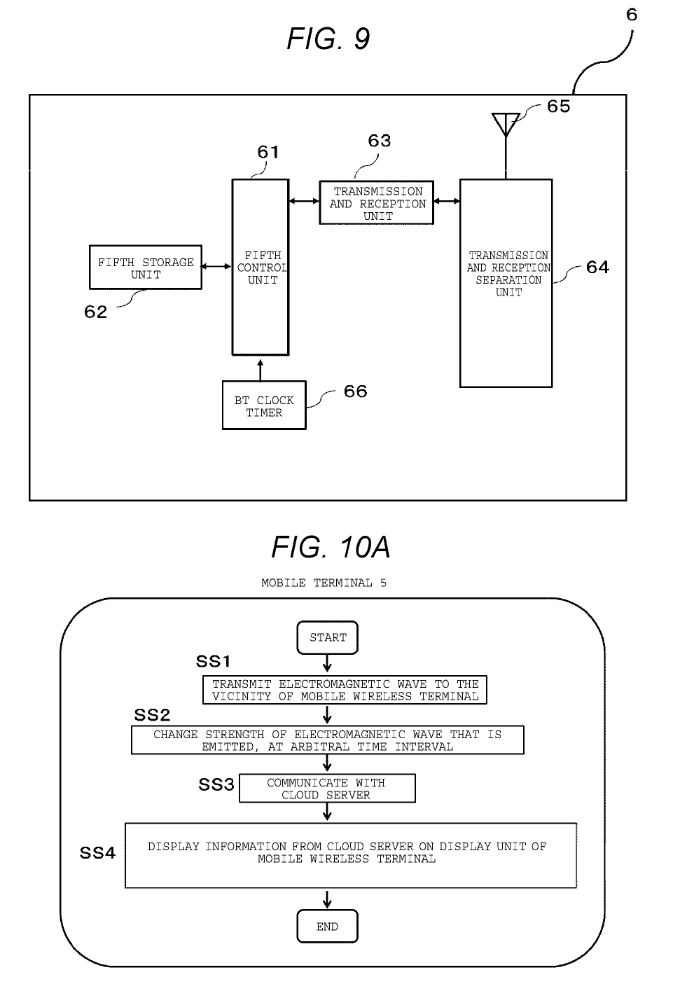

Next, FIG. 9 is a block diagram illustrating a configuration of the reception apparatus 6.

The reception apparatus 6, as illustrated in FIG. 9, has a fifth control unit 61, a fifth storage unit 62, a transmission and reception unit 63, a transmission and reception separation unit 64, a transmission and reception antenna 65, a clock timer 66, and the like.

The fifth control unit 61, for example, controls the entire reception apparatus 6, and includes a CPU as a main component. The fifth control unit 61, for example, performs a control operation in accordance with a control program that is stored in the fifth storage unit 62.

Programs 62a and 62b that are executed by the fifth control unit 61 are stored in the fifth storage unit 62. The fifth storage unit is, for example, a ROM, a RAM, an EEPROM, or the like. Furthermore, when an operation is performed by the fifth control unit 61, the fifth storage unit 62 functions as a working memory.

A BLUETOOTH® address (BT address) of the reception apparatus 6, pieces of data for various frequency hopping patterns at the times of inquiry, calling, and communication, and the like are used by the communication control program 62a and are stored in the fifth storage unit 62. Furthermore, a location detection processing routine that determines a location of the mobile wireless terminal 5 is also included in the location determination program 62b that is stored in the fifth storage unit 62.

When functioning as a transmission unit, the transmission and reception unit 63 converts transmission packet data that is provided from the fifth control unit 61, into an RF signal, and provides the resulting radio frequency signal to the transmission and reception antenna 65 through the transmission and reception separation unit 64, for transmission. Furthermore, when the transmission and reception unit 63 functions as a reception unit, the transmission and reception antenna 65 converts a reception RF signal that is provided through the transmission and reception separation unit 64, into a reception packet data, and provides the resulting reception packet data to the fifth control unit 61. Furthermore, the transmission unit and the reception unit may be separately provided.

The transmission and reception separation unit 64, which is a circuit, e.g., a duplex circuit, separates the transmission system and the reception system. Ina case where a transmission antenna and a reception antenna are separately provided, the transmission and reception separation unit 64 is unnecessary.

The transmission and reception antenna 65 transmits a transmission RF signal wirelessly and converts an arrival electromagnetic wave (e.g., a reception RF signal) into an electric signal. The transmission and reception antenna 65 is omnidirectional.

The clock timer 66 is a timer that generates various clock signals, such as BLUETOOTH® clock signals (BT clocks), that specify a time position along the time axis.

### Operation

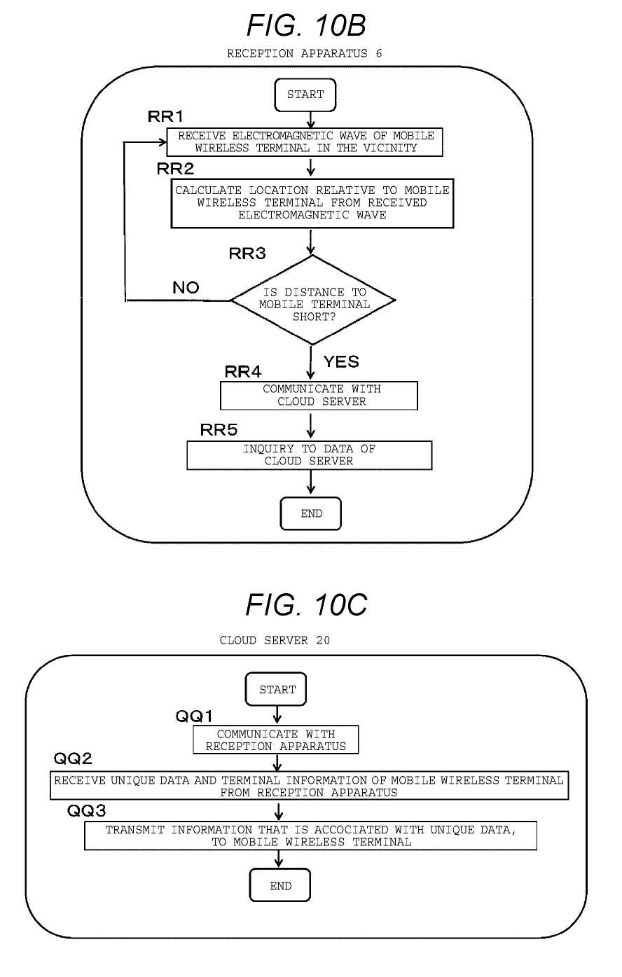

Next, the operation of the second embodiment is described with reference to the flowcharts in FIGS. 10A to 10C.

As illustrated in FIG. 10A, the mobile wireless terminal 5 transmits a wireless signal that carries apparatus-unique data (e.g., ID, location information, or the like), as an electromagnetic wave (Step SS1). At that time, the strength of the electromagnetic wave that is transmitted at an arbitrary time interval is changed by the wireless electromagnetic wave strength variable unit 49 (Step SS2). Next, communication with the cloud server 20 is started, and information (e.g., location information of the reception apparatus 6 and map information on the surroundings, a coupon ticket, or the like) that is allocated to each reception apparatus 6 is received from the cloud server 20 (Step SS3). The information that is received from the cloud server 20 is displayed on a display unit of the mobile wireless terminal 5 (Step SS4).

On the other hand, the reception apparatus 6, as illustrated in FIG. 10B, first receives an electromagnetic wave from the mobile wireless terminal 5 in the vicinity (Step RR1). Next, the fifth control unit 61 of the reception apparatus 6 calculates a location relative to the mobile wireless terminal 5 based on the change in the electromagnetic wave strength of the received electromagnetic wave (Step RR2). The fifth control unit 61 of the reception apparatus 6 compares the calculated relative location with a threshold (which is a reference value when it is determined that a distance between the reception apparatus and the mobile wireless terminal is short) that is set in advance, and determines whether or not the mobile wireless terminal 5 is located in the vicinity of the reception apparatus 6 (Step RR3). In a case where it is determined that the distance between the reception apparatus 6 and the mobile wireless terminal 5 is not short (NO in Step RR3), processing returns to step R1. On the other hand, in a case where it is determined that the distance between the reception apparatus 6 and the mobile wireless terminal 5 is short (YES in Step RR3), the reception apparatus 6 starts the communication with the cloud server 20 (Step RR4). The fifth control unit 61 of the reception apparatus 6 requests the received unique data of the mobile wireless terminal 5 from the cloud server 20 (Step RR5). It is noted that at this time, a display unit may be provided on the reception apparatus 6 to receive information from a server and display the received information on the display unit.

The cloud server 20, as illustrated in FIG. 10C, first starts communication with the reception apparatus 6 (Step QQ1). Next, the cloud server 20 receives, from the reception apparatus 6 that is connected for communication, the unique data and terminal information (e.g., an ID of the mobile wireless terminal or the like) of the mobile wireless terminal 5, which is retained by the reception apparatus 6 (Step QQ2). The cloud server 20 transmits information (e.g., the location information of the reception apparatus 6 and the map information on the surroundings, the coupon ticket, or the like) that corresponds to unique data of the reception apparatus 6 to the mobile wireless terminal 5 (Step QQ3).

### Operation and Effect

Because the mobile wireless terminal 5 sends out a wireless signal by varying the strength of the electromagnetic wave, the reception apparatus 6 that performs reception can uniquely identify an electromagnetic wave of the mobile wireless terminal 5 with precision based on the high and low levels of the electromagnetic strength, and can specify the location of the mobile wireless terminal 5. Furthermore, it is also possible that the mobile wireless terminal acquires information on the vicinity of the reception apparatus 6 through the cloud server. Moreover, even in a case where the mobile wireless terminal is always in a reception state, power consumption can be reduced.

Moreover, in the location determination system 200 according to the second embodiment, it is also possible that the precision of the location is increased by increasing the number of reception apparatuses 6 to two or more in the same manner as in the first embodiment.

As described above, the mobile wireless terminal 5 receives a signal from a global positioning system (GPS) satellite, and thus can specify a location of the mobile wireless terminal equipped with the wireless function, with higher precision inside of a house or a vehicle in which the location information cannot be acquired from a GPS satellite.

### Third Embodiment

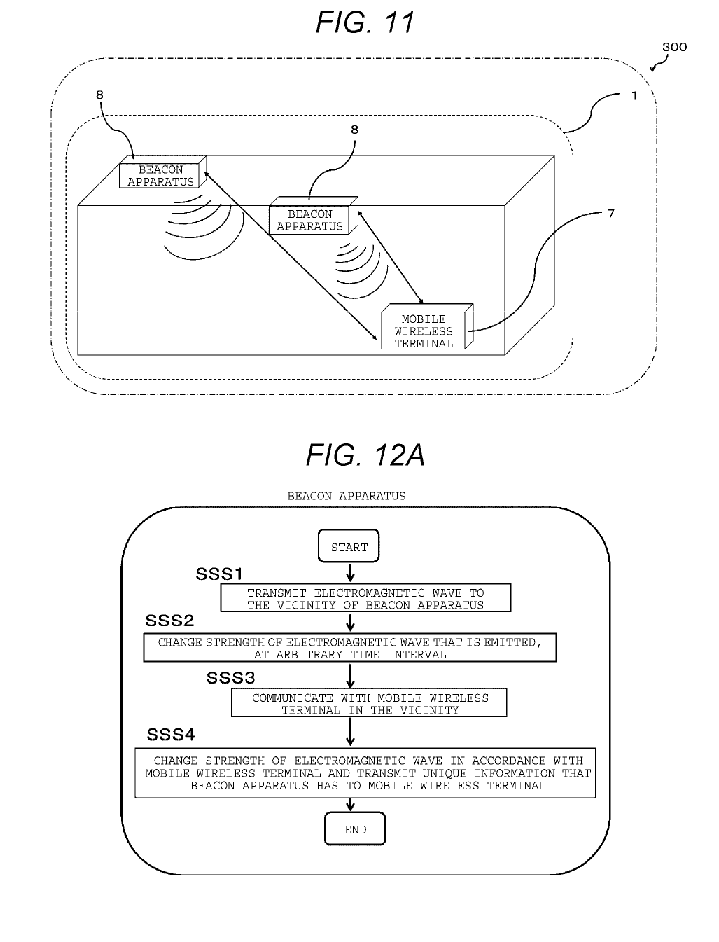

Next, a third embodiment is described. FIG. 11 is a reference diagram of a location determination system 300 according to the third embodiment.

In order to specify a place in which a mobile wireless terminal 7 is positioned with respect to a beacon apparatus 8, the beacon apparatus 8 that includes a bidirectional communication function is installed in a certain fixed place. The beacon apparatus 8 sends out a wireless signal that includes unique data while varying the strength of the electromagnetic wave at an arbitrary time interval. When the mobile wireless terminal 7 in which the unique data is registered in advance approaches the beacon apparatus 8, it is determined from the strength of the electromagnetic wave of the mobile wireless terminal 7 and the unique data of the beacon apparatus 8 that the beacon apparatus 8 is located nearby, and thus bidirectional communication is started. When wireless communication is performed between the beacon apparatus 8 and the mobile wireless terminal 7 with the strength of the electromagnetic wave being varied, the location of the mobile wireless terminal 7 with respect to the beacon apparatus 8 can be specified.

A difference between the first embodiment and the second embodiment is described. Configurations of the mobile wireless terminal 7 and the beacon apparatus 8 are the same configuration as the mobile wireless terminal and the beacon apparatus that are described in the first embodiment and the second embodiment.

In a location determination system 300 according to the third embodiment, the beacon apparatus 8 and the mobile wireless terminal 7 perform communication with each other without the cloud server 20 of the first embodiment being involved. The relative location of the mobile wireless terminal 7 is determined with precision by performing communication while varying the strength of the electromagnetic wave.

### Operation

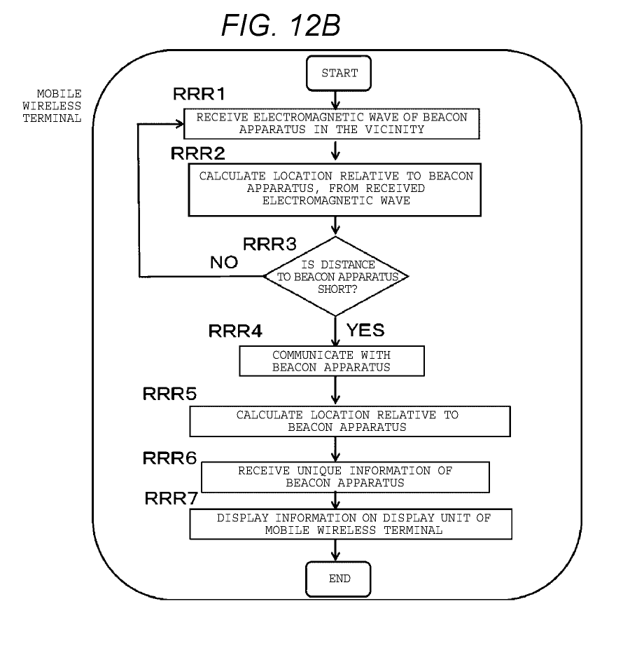

Next, the operation of the third embodiment is described with reference to flowcharts with reference to FIG. 12A to 12B.

As illustrated in FIG. 12A, the beacon apparatus 8 transmits a wireless signal that carries apparatus-unique data (e.g., ID, location information, or the like), as an electromagnetic wave (Step SSS1). At that time, the strength of the electromagnetic wave that is transmitted at an arbitrary time interval is changed by a wireless electromagnetic wave strength variable unit 34 (Step SSS2). Next, communication with the mobile wireless terminal 7 in the vicinity, which receives the electromagnetic wave is started (Step SSS3). The strength of the electromagnetic wave that is transmitted by the beacon apparatus 8 toward the mobile wireless terminal 7 which performs communication is changed in a manner that is again suitable for the mobile wireless terminal 7 (Step SSS4).

On the other hand, as illustrated in FIG. 12B, the mobile wireless terminal 7 first receives an electromagnetic wave from the beacon apparatus 8 in the vicinity (Step RRR1). Next, the mobile wireless terminal 7 calculates a location relative to the beacon apparatus 8 from the change in the strength of the received electromagnetic wave (Step RRR2). A fifth control unit 53 of the mobile wireless terminal 7 compares the calculated relative location with a threshold (which is a reference value when it is determined that the distance to the beacon apparatus is short) that is set in advance, and determines whether or not the mobile wireless terminal 7 is located in the vicinity of the beacon apparatus 8 (Step RRR3). In a case where it is determined that a distance between the beacon apparatus 8 and the mobile wireless terminal 7 is not short (NO in Step RRR3), processing returns to step RRR1. On the other hand, in a case where it is determined that the distance between the beacon apparatus 8 and the mobile wireless terminal 7 is short (YES in Step RRR3), the mobile wireless terminal 7 starts communication with the beacon apparatus 8 (Step RRR4). At the time of wireless communication, the strength of the electromagnetic wave that is sent out by the beacon apparatus 8 is varied and the higher-precision relative location is determined. At that time, the mobile wireless terminal 7 may be able to arbitrarily adjust the strength of the electromagnetic wave with respect to the beacon apparatus 8 (Step RRR5). Thereafter, from the wireless signal from the beacon apparatus 8, the mobile wireless terminal 7 receives unique information (e.g., information relating to the vicinity of the beacon apparatus 8, the coupon ticket, or the like) that is retained by the beacon apparatus 8 (Step RRR6). It is noted that at this time, the received unique information may be included in the electromagnetic wave that is received in Step RRR1. Next, the mobile wireless terminal 7 displays the received information on a display unit (Step RRR7).

### Operation and Effect

When the unique data of the beacon apparatus is output, the strength of the electromagnetic wave is changed, and thus on the mobile wireless terminal 7 side, the location relative to the beacon apparatus 8 can be determined with precision. Furthermore, when the mutual communication between the mobile wireless terminal 7 and the beacon apparatus 8 is performed, the function of adjusting the strength of the electromagnetic wave from the beacon apparatus to the mobile wireless terminal is added. Thus it is also possible that the location of the mobile wireless terminal 7 relative to the beacon apparatus 8 is determined with precision. Moreover, a plurality of beacon apparatuses 8 are present in the same manner as in the first and second embodiments, it is possible that the precision of the location of the mobile wireless terminal 7 is increased.

Furthermore, when the third embodiment is described, the description is provided using the beacon apparatus 8. However, the beacon apparatus 8 is replaced with the reception apparatus 6 as in the second embodiment, and thus communication may be performed with the strength of the electromagnetic wave being varied by the mobile wireless terminal 7.

While certain embodiments have been described, these embodiments have been presented by way of example only, and are not intended to limit the scope of the inventions . Indeed, the novel embodiments described herein may be embodied in a variety of other forms; furthermore, various omissions, substitutions and changes in the form of the embodiments described herein may be made without departing from the spirit of the inventions. One skilled in the art would appropriately choose the specific configuration of each element included in the embodiments from the know arts. The accompanying claims and their equivalents are intended to cover such forms or modifications as would fall within the scope and spirit of the inventions.

1. A mobile wireless terminal comprising:
a display device;
a transmission and reception circuit including an antenna that transmits and receives wireless signals; and
a processor configured to:
receive, via the antenna, a wireless signal having a periodic variation in transmission strength from a wireless device,
calculate a location of the mobile wireless terminal based on the periodic variation in transmission strength of the wireless signal,
based on the calculated location of the mobile wireless terminal, determine whether a distance from the mobile wireless terminal to the wireless device is less than a predetermined threshold,
when the distance from the mobile wireless terminal to the wireless device is less than a predetermined threshold, transmit a request, via the antenna, for information associated with the wireless device,
receive, in response to the request via the antenna, the information associated with the wireless device, and
control the display device to display a screen that includes the information associated with the wireless device.

2. The mobile wireless terminal according to claim 1, wherein
the request for information associated with the wireless device is transmitted to a server, and
the information associated with the wireless device is received from the server.

3. The mobile wireless terminal according to claim 1, wherein the request for information associated with the wireless device is transmitted to the wireless device, and
the information associated with the wireless device is received from the wireless device.

4. The mobile wireless terminal according to claim 3, wherein the location of the mobile wireless terminal is further calculated based on bi-directional communication with the wireless device.

5. The mobile wireless terminal according to claim 1, wherein the displayed screen that includes the information associated with the wireless device is a coupon image for a store associated with the wireless device.

6. The mobile wireless terminal according to claim 1, wherein the location of the mobile wireless terminal is calculated without receiving a signal from a GPS satellite.

7. The mobile wireless terminal according to claim 1, wherein
the wireless device is one of a plurality of wireless devices, and
the location of the mobile wireless terminal is further calculated based on respective location information associated with each wireless device included in the wireless signal from each wireless device, respectively.

8. A mobile wireless terminal comprising:
a display device;
a transmission and reception circuit including an antenna that transmits and receives wireless signals; and
a processor configured to:
transmit, to a plurality of wireless devices via the antenna, a wireless signal that periodically varies in transmission strength,
transmit a request, via the antenna, for information associated with one of the plurality of wireless devices that is determined to have a distance to the mobile wireless terminal less than a predetermined threshold,
receive, in response to the request via the antenna, the information associated with the one wireless device, and
control the display device to display a screen that includes the information associated with the one wireless device.

9. The mobile wireless terminal according to claim 8, wherein
the request for information associated with the one wireless device is transmitted to a server, and
the information associated with the one wireless device is received from the server.

10. The mobile wireless terminal according to claim 8, wherein the information associated with the one wireless device includes at least one of location information of the one wireless device and a coupon for a store associated with the one wireless device.

11. The mobile wireless terminal according to claim 8, wherein the information associated with the one wireless device includes map information in a vicinity of the one wireless device.

12. The mobile wireless terminal according to claim 8, wherein the processor is further configured to:
receive, via the antenna, location information of the mobile wireless terminal that is calculated by the wireless device based on the periodic variation in transmission strength of the wireless signal, and
control the display device to display the location information.

13. A method of providing location-specific information to a mobile wireless terminal, the method comprising:
communicating, between an wireless device and the mobile wireless terminal, a wireless signal that periodically varies in transmission strength;
calculating a location of the mobile wireless terminal based on the periodic variation in transmission strength of the wireless signal;
based on the calculated location of the mobile wireless terminal, determining whether a distance from the mobile wireless terminal to the wireless device is less than a predetermined threshold;
when the distance from the mobile wireless terminal to the wireless device is less than a predetermined threshold, transmitting a request for information associated with the wireless device;
receiving, in response to the request, the information associated with the wireless device; and
displaying a screen that includes the information associated with the wireless device.

14. The method according to claim 13, wherein
the request for information associated with the wireless device is transmitted to a server, and
the information associated with the wireless device is received from the server.

15. The method according to claim 13, wherein
the request for information associated with the wireless device is transmitted to the wireless device, and
the information associated with the wireless device is received from the wireless device.

16. The method according to claim 13, wherein the displayed screen that includes the information associated with the wireless device is a coupon image for a store associated with the wireless device.

17. The method according to claim 13, wherein the location of the mobile wireless terminal is calculated without receiving a signal from a GPS satellite.

18. The method according to claim 13, wherein
the wireless device includes a plurality of wireless devices, and
the location of the mobile wireless terminal is further calculated based on respective location information associated with each wireless device included in the wireless signal from each wireless device, respectively.

19. The method according to claim 13, wherein
the wireless signal that periodically varies in transmission strength is transmitted from the mobile wireless terminal, and
the wireless device calculates the location of the mobile wireless terminal.

20. The method according to claim 13, wherein
the wireless signal that periodically varies in transmission strength is transmitted from the wireless device, and
the mobile wireless terminal calculates the location of the mobile wireless terminal.
